(19) United States
(12) Patent Application Publication
(10) Pub. No.: US 2009/0073700 A1
(43) Pub. Date: Mar. 19, 2009

(54) Light Emitting Diode Package Assembly

(76) Inventor: William T. Cruickshank, Rochester hills, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/855,125

(22) Filed: Sep. 13, 2007

(51) Int. Cl. F21V 29/00; H01J 9/00

(52) U.S. Cl. 362/373; 362/362; 445/23

(57) ABSTRACT

A light emitting diode package assembly is provided including a lower housing element and an upper housing element creating an internal pcb storage chamber. A light emitting diode driver pcb is mounted within. A light emitting diode pcb is mounted within and includes a light emitting diode element and a touch switch antenna. A personality pcb mounted is within between the light emitting diode driver pcb and the light emitting diode pcb. The personality pcb comprises touch switch circuitry and theatre dimming circuitry. At least one pcb interconnect places the light emitting diode driver pcb, the light emitting diode pcb and the personality pcb in communication with each other.

### TECHNICAL FIELD

The present invention relates generally to a light emitting diode package assembly and more particularly to an LED package assembly with improve profile and functionality.

### BACKGROUND OF THE INVENTION

Automotive environments provide an extensive array of challenges towards engineering design. One challenge has been to control advanced electronics. A common approach is to interconnect electronics from across the vehicle with remote processors that provide advanced functionality to these electronics. This approach, however, is costly and time consuming. In many situations the remote location of the electronics further complicates assembly.

In simple electronics such as lighting a variety of advanced features are presently desirable. The simplicity of these electronics further weights against complex remote wiring. It is often highly desirable for these assemblies to be relatively self contained and self sufficient. It is desirable to incorporate a level of control directly into the electronics such that outboard processing control is wholly unnecessary. Lighting features such as dimming or touch switch activation, in integrated into the light feature itself, would be highly desirable and cost effective.

As such it would be highly desirable to have a light assembly that comprised a light emitting diode package assembly. It would also be highly desirable for such a light assembly to have internally incorporated control and personality features such that a cost effective and stand alone light assembly is produced.

### SUMMARY OF THE INVENTION

In accordance with the desires of the present invention A light emitting diode package assembly is provided including a lower housing element and an upper housing element creating an internal pcb storage chamber. A light emitting diode driver pcb is mounted within. A light emitting diode pcb is mounted within and includes a light emitting diode element and a touch switch antenna. A personality pcb mounted is within between the light emitting diode driver pcb and the light emitting diode pcb. The personality pcb comprises touch switch circuitry and theatre dimming circuitry. At least one pcb interconnect places the light emitting diode driver pcb, the light emitting diode pcb and the personality pcb in communication with each other.

Other objects and features of the present invention will become apparent when viewed in light of the detailed description and preferred embodiment when taken in conjunction with the attached drawings and claims.

### BRIEF DESCRIPTION OF THE DRAWINGS

FIG. 1 is an illustration of a light emitting diode package assembly in accordance with the present invention.

FIG. 2 is a block diagram of the light emitting diode package assembly illustrated in FIG. 1.

FIG. 3 is a cross-sectional illustration of the light emitting diode package assembly illustrated in FIG. 1.

### DESCRIPTION OF PREFERRED EMBODIMENTS

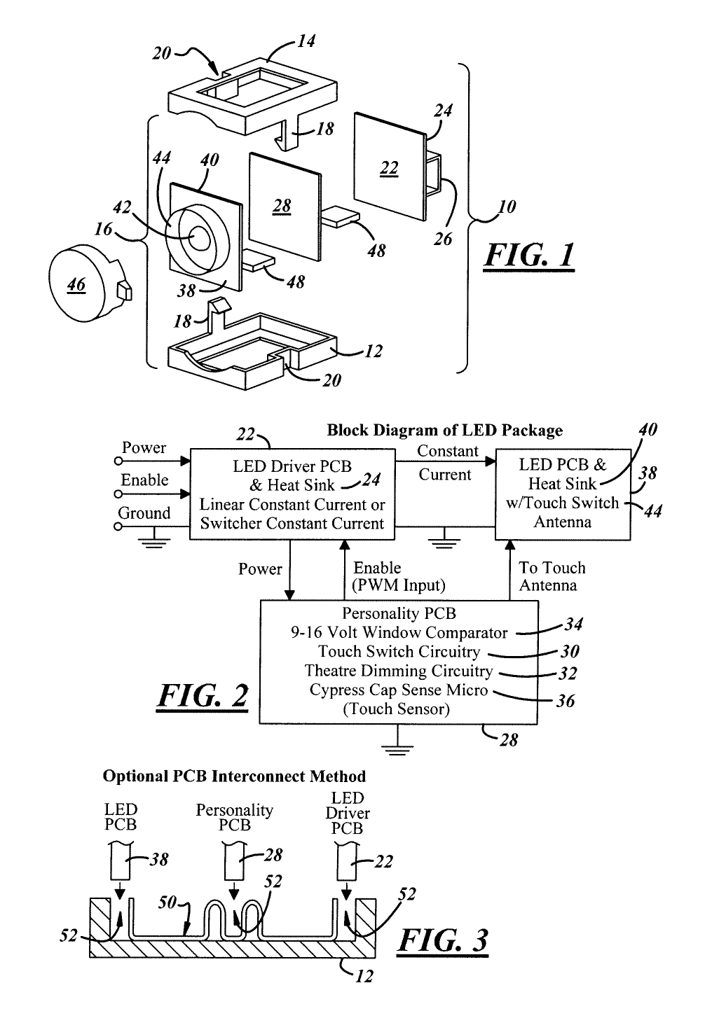

Referring now to FIG. 1, which is an illustration of a light emitting diode package assembly 10 in accordance with the present invention. The light emitting diode package assembly 10 is intended for use in vehicles to replace incandescent lights. The light emitting diode package assembly 10 provided is a stand alone package with reduced size and reduced manufacturing costs.

The light emitting diode package assembly 10 includes a lower housing element 12 and an upper housing element 14. These elements 12,14 are preferably open-frame elements as illustrated that join together to form a internal pcb storage chamber 16. In one embodiment it is contemplated that the upper and lower housing element 12,14 are identical elements with a latch arm 18 on one side and a latch catch 20 on the other. In this fashion a single piece may be manufactured and utilized for both the upper and lower housing elements 12,14

Positioned within the internal pcb storage chamber 16 are mounted three pcb boards. These three pcb boards include a light emitting diode driver pcb 22 (LED driver pcb). The LED driver pcb 22 includes a driver heat sink 24. In the embodiment illustrated the LED driver pcb 22 is a 30 mm×30 mm heat sink pcb and therefore incorporates the driver heat sink 24. It is contemplated, however, that the driver heat sink 24 may be a separate element in other embodiments. The LED driver pcb 22 is preferably either a linear constant current driver or a switcher constant current driver. A wire harness connector 26 is preferably mounted to the LED driver pcb 22.

Positioned parallel to the LED driver pcb 22 but non-planar is a personality pcb 28. A personality pcb 28 is intended to cover a pcb incorporating logic circuitry capable of providing intelligence to the LED package assembly 10. In the present invention it is contemplated that the personality pcb 28 includes both touch switch circuitry 30 as well as theatre dimming circuitry 32. It is contemplated that the personality pcb 28 may further include a 9-16 volt window comparator 34 as well as a micro-sensor 36 to perform the touch switch functions.

The invention further includes a light emitting diode pcb 38 (LED pcb) mounted within the internal pcb storage chamber 16. The LED pcb 38 is also mounted non-planar and parallel to the LED driver pcb 22. These pcb boards 22, 28, 38 are preferably mounted such that the personality pcb 28 is sandwiched between the LED driver pcb 22 and the LED pcb 38. The LED pcb 38 preferably includes a LED heat sink 40. Such as the LED driver pcb 22, the LED pcb 38 is preferably a 30 mm×30 mm heat sink pcb such that the LED heat sink 40 is directly incorporated into the LED pcb 38. An LED element 42 is mounted onto the LED pcb 38. A touch switch antenna 44 is mounted surrounding the LED element 42. A lens 46 is also mounted surrounding both the LED element 42 and the touch switch antenna 44.

Finally, a pcb interconnect 48 is positioned between the pcb boards 22, 28, 38 such that they are placed in electrical communication with each other. In one embodiment it is contemplated that the pcb interconnect 48 may comprise a plurality of electrical communication elements positioned between the boards. In another embodiment, however, it is contemplated hat the pcb interconnect 48 comprises a single continuous bent wire pcb interconnect 50 as illustrated in FIG. 3. The continuous bent wire pcb interconnect 50 is preferably bent to form engagement slots 52 within the upper and/or lower housing 12,14 such that the pcb's 22,28,38 are retained within position within the internal pcb storage chamber 16.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A light emitting diode package assembly comprising:
a lower housing element;
an upper housing element engaging said lower housing element to create an internal pcb storage chamber;
a light emitting diode driver pcb mounted within said internal pcb storage chamber;
a light emitting diode pcb mounted within said internal pcb storage chamber, said light emitting diode pcb including a light emitting diode element and a touch switch antenna;
a personality pcb mounted within said internal pcb storage chamber in between said light emitting diode driver pcb and said light emitting diode pcb, said personality pcb comprising touch switch circuitry and theatre dimming circuitry; and
at least one pcb interconnect placing said light emitting diode driver pcb, said light emitting diode pcb and said personality pcb in communication with each other.

2. A light emitting diode package assembly as described in claim 1, wherein said personality pcb further comprises a 9 to 16 volt comparator.

3. A light emitting diode package assembly as described in claim 1, wherein said light emitting diode driver pcb includes a driver heat sink.

4. A light emitting diode package assembly as described in claim 3, wherein said diver heat sink comprises a constant current driver heat sink.

5. A light emitting diode package assembly as described in claim 1, wherein said lower housing element and said upper housing element comprise open frame housing elements.

6. A light emitting diode package assembly as described in claim 1, wherein said at least one pcb interconnect comprises a single continuous bent wire pcb interconnect.

7. A light emitting diode package assembly as described in claim 1, wherein said light emitting diode pcb includes a diode pcb heat sink.

8. A light emitting diode package assembly as described in claim 7, wherein said light emitting diode pcb comprises a 30mm×30 mm heat sink pcb.

9. A light emitting diode package assembly as described in claim 1, further comprising:
a wire harness connector mounted to said light emitting diode driver pcb.

10. A light emitting diode package assembly as described in claim 1, wherein said light emitting diode driver pcb, said light emitting diode pcb, and said personality pcb are orientated in a non-planar parallel orientation.

11. A light emitting diode package assembly comprising:
a light emitting diode driver pcb;
a light emitting diode pcb including a light emitting diode element;
a personality pcb mounted in between said light emitting diode driver pcb and said light emitting diode pcb, said personality pcb comprising touch switch circuitry; and
at least one pcb interconnect placing said light emitting diode driver pcb, said light emitting diode pcb and said personality pcb in communication with each other.

12. A light emitting diode package assembly as described in claim 11, wherein said personality pcb further comprises theatre dimming circuitry.

13. A light emitting diode package assembly as described in claim 11, further comprising:
an open frame lower housing element;
an open frame upper housing element engaging said open frame lower housing element to create an internal pcb storage chamber, said light emitting diode driver pcb, said light emitting diode pcb and said personality pcb mounted within said internal pcb storage chamber.

14. A light emitting diode package assembly as described in claim 11, wherein said light emitting diode pcb further comprises:
a touch switch antenna surrounding said light emitting diode element; and
a lens covering said touch switch antenna.

15. A light emitting diode package assembly as described in claim 11, wherein said light emitting diode driver pcb comprises a heat sink pcb.

16. A light emitting diode package assembly as described in claim 11, wherein said light emitting diode pcb comprises a heat sink pcb.

17. A light emitting diode package assembly as described in claim 11, further comprising:
a wire harness connector mounted to said light emitting diode driver pcb.

18. A method of manufacturing a light emitting diode package assembly comprising:
mounting a pcb interconnect within a lower housing element;
mounting a light emitting diode driver pcb in said lower housing element;
mounting a light emitting diode pcb in said lower housing element such that it is positioned parallel to and non-planar to said light emitting diode driver pcb, said light emitting diode pcb including a light emitting diode element and a touch switch antenna;
mounting a personality pcb in said lower housing element such that said personality pcb is positioned in between said light emitting diode driver pcb and said light emitting diode pcb, said personality pcb including touch switch circuitry and theatre dimming circuitry, said pcb interconnect placing said light emitting diode driver pcb, said light emitting diode pcb and said personality pcb in communication with each other; and
placing an upper housing element in communication with said lower housing element, said upper housing element securing said light emitting diode driver pcb, said light emitting diode pcb and said personality pcb within said lower housing element.

19. A method as described in claim 18, wherein said upper housing element and said lower housing element comprise open frame housing elements.

20. A method as described in claim 18, wherein said pcb interconnect comprises a single continuous bent wire pcb interconnect.
